(19) United States
(12) Patent Application Publication
(10) Pub. No.: US 2005/0227172 A1
(43) Pub. Date: Oct. 13, 2005

(54) Process for producing photoresist composition, filtration device, application device, and photoresist composition

(76) Inventors: Hirokazu Ozaki, Kawasaki-shi (JP); Masaaki Muroi, Kawasaki-shi (JP); Tsunehiro Watanabe, Kawasaki-shi (JP); Shinya Narumi, Kawasaki-shi (JP)

Correspondence Address: KNOBBE MARTENS OLSON & BEAR LLP, 2040 MAIN STREET, FOURTEENTH FLOOR, IRVINE, CA, 92614, US

(21) Appl. No.: 11/099,182

(22) Filed: Apr. 5, 2005

(30) Foreign Application Priority Data
Apr. 8, 2004 (JP) 2004-114126

(51) Int. Cl. G03C 1/492

(52) U.S. Cl. 430/270.1

(57) ABSTRACT

A process for producing a photoresist composition which is capable of suppressing the occurrence of defects, and displays excellent foreign matter characteristics, and superior storage stability as a resist solution. This process involves passing a photoresist composition, comprising a resin component (A) that satisfies a condition (1) below, an acid generator component (B), and an organic solvent (C), through a first filter including a first filtration membrane that satisfies a condition (2) below. (1) The resin component (A) comprises a structural unit (a1) represented by a general formula (I) shown below, and a structural unit (a2) containing an acid dissociable, dissolution inhibiting group. 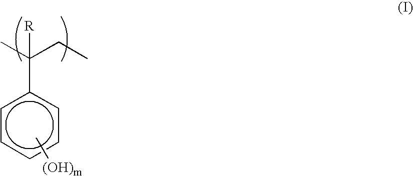 (wherein, R represents a hydrogen atom or a methyl group, and m represents an integer from 1 to 3). (2) The first filtration membrane has a critical surface tension of at least 70 dyne/cm, and has not been subjected to charge modification.

### CROSS-REFERENCE TO RELATED APPLICATION

This application is based on Japanese Patent Application No. 2004-114126, filed in Japan, on Apr. 8, 2004, the content of which is incorporated herein by reference.

### BACKGROUND OF THE INVENTION

1. Field of the Invention

The present invention relates to a process for producing a photoresist composition, a filtration device, an application device, and a photoresist composition, and is particularly suited to the treatment of photoresist compositions for use with KrF excimer lasers.

2. Description of Related Art

Chemically amplified photoresist compositions for use with light sources (radiation sources) such as KrF excimer lasers, ArF excimer lasers, F₂ excimer lasers, EUV (extreme ultraviolet light), and EB (electron beams) and the like typically comprise a resin component (A), an acid generator component (B) that generates acid on exposure, and an organic solvent (C) capable of dissolving these components, as disclosed in Japanese Unexamined Patent Application, First Publication No. 2002-296779.

These types of chemically amplified photoresist compositions must display high levels of resolution and sensitivity, and enable the formation of resist patterns of favorable shape.

Furthermore, in recent years, with the growing demand for high resolution resist patterns of no more than 0.16 microns, an improvement, beyond conventional levels, in the level of resist pattern defects (surface defects) following developing is now also becoming necessary.

This term “defects” is a general term describing all irregularities detected by inspecting the developed resist pattern from directly overhead using a surface defect inspection apparatus, such as that manufactured by KLA Tencor Corporation (brand name “KLA”). These irregularities include scum (mainly undissolved residues and the like) left following developing, as well as bubbles, dust, and bridges between sections of the resist pattern. Bridges and scum are particularly undesirable in terms of achieving a high level of resolution.

Until now, most attempts at improving the level of these types of defects have focused on improving the resin component, the acid generator component, or the solvent component of the resist composition [see Japanese Unexamined Patent Application, First Publication No. 2001-56556 (patent reference 2)].

Furthermore, even if the composition is altered, if foreign matter such as fine particles exist within the final resist, then these will cause defects. In this description, for the sake of convenience, this existence of foreign matter within the resist composition is termed the “foreign matter characteristics”.

Furthermore, during storage, the appearance of newly formed fine particles (the appearance of solid foreign matter within the photoresist composition during storage of the composition) causes a problem in terms of the storage stability as a resist solution, and improvements in this property are also needed.

As above, attempts to improve this storage stability as a resist solution have focused on improvements to the resist composition [see Japanese Unexamined Patent Application, First Publication No. 2001-22072 (patent reference 3)].

However, the effects of the technology disclosed in the patent references 2 and 3 are still not entirely satisfactory.

Accordingly, the removal of fine particles from the resist composition immediately following production, and an improvement in the storage stability as a resist solution are greatly needed. If these factors can be improved, then an improvement in the level of defects can also be expected.

However, until now a process for satisfactorily improving the level of resist pattern defects following developing, as well as improving the foreign matter characteristics and the storage stability, has proven elusive.

Japanese Unexamined Patent Application, First Publication No. 2002-62667 (patent reference 4) proposes a process for producing a photoresist composition, in which by passing the photoresist composition through a filter, the quantity of fine particles within the photoresist composition circulating through the line is reduced.

As disclosed in this patent reference 4, the passing of a photoresist composition through a filter during the production of the photoresist composition is already known, although this type of conventional process does not provide a satisfactory degree of improvement in the level of resist pattern defects following developing, the foreign matter characteristics, or the storage stability.

In addition, Japanese Unexamined Patent Application, First Publication No. 2001-350266 (patent reference 5) proposes a process for producing a photoresist composition in which the composition is passed through a filter with a positive zeta potential. However, the object of this invention is to suppress pinhole defects within the resist coating film, and according to investigations conducted by the inventors of the present invention, when used with photoresist compositions for KrF excimer lasers, comprising a hydroxystyrene resin containing hydroxystyrene structural units as a base resin, this process does not provide adequate suppression of defects such as post-developing scum or resist pattern bridges, or adequate improvement in the foreign matter characteristics or storage stability as a resist solution, or adequate stability in the size of the formed resist pattern (the property wherein the pattern size displays minimal fluctuation as a result of the filtration).

In addition, of the various types of resist pattern defects that exist following developing, resolving the defect problems that appear during the formation of very fine resist patterns with pattern sizes of no more than 160 nm, which are produced using KrF excimer lasers onwards as the light source, namely, KrF excimer lasers, ArF excimer lasers, F₂ excimer lasers, EUV, and EB and the like, is now becoming critical.

Recently, the level of resolution demanded from each of the various types of light sources has increased even further, and the detection level for defects has also improved, meaning the resolution of defect problems associated with photoresist compositions for KrF excimer lasers is becoming very critical.

[Patent Reference 1]

Japanese Unexamined Patent Application, First Publication No. 2002-296779

[Patent Reference 2]

Japanese Unexamined Patent Application, First Publication No. 2001-56556

[Patent Reference 3]

Japanese Unexamined Patent Application, First Publication No. 2001-22072

[Patent Reference 4]

Japanese Unexamined Patent Application, First Publication No. 2002-62667

[Patent Reference 5]

Japanese Unexamined Patent Application, First Publication No. 2001-350266

### SUMMARY OF THE INVENTION

The present invention takes the above circumstances into consideration, with an object of providing technology which, for photoresist compositions comprising a so-called hydroxystyrene resin containing hydroxystyrene structural units as a base resin, enables the production of a photoresist composition that enables the suppression of resist pattern defects that occur following developing, and particularly the occurrence of fine scum and microbridges.

Furthermore, another object of the present invention is to provide technology that enables the production of a photoresist composition with superior foreign matter characteristics.

In addition, yet another object of the present invention is to provide technology that enables the production of a photoresist composition with excellent storage stability as a resist solution.

In addition, yet another object of the present invention is to provide technology that enables the production of a photoresist composition which forms a resist pattern with excellent resist pattern size stability.

In order to achieve these objects, the present invention employs the aspects described below.

A first aspect of the present invention is a process for producing a photoresist composition, comprising the step of passing a photoresist composition, comprising a resin component (A) that satisfies a condition (1) below, an acid generator component (B) that generates acid on exposure, and an organic solvent (C), through a first filter equipped with a first filtration membrane that satisfies a condition (2) below.
(1) The resin component (A) comprises a structural unit (a1) represented by a general formula (I) shown below, and a structural unit (a2) containing an acid dissociable, dissolution inhibiting group. 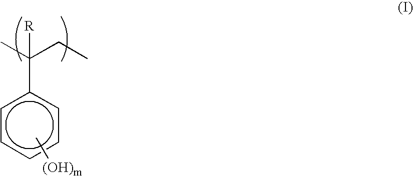
   (wherein, R represents a hydrogen atom or a methyl group, and m represents an integer from 1 to 3)
(2) The first filtration membrane has a critical surface tension of at least 70 dyne/cm, and has not been subjected to charge modification.

A second aspect is a filtration device comprising a first filtration portion, through which is passed a photoresist composition comprising a resin component (A), an acid generator component (B) that generates acid on exposure, and an organic solvent (C), wherein the filtration device satisfies the conditions (i) and (ii) described below.
(i) The first filtration portion comprises a first filter equipped with a first filtration membrane, and this first filtration membrane has a critical surface tension of at least 70 dyne/cm, and has not been subjected to charge modification.
(ii) The filtration device is used for filtering a photoresist composition containing a resin component (A) that comprises a structural unit (a1) represented by a general formula (I) shown above, and a structural unit (a2) containing an acid dissociable, dissolution inhibiting group.

A third aspect is an application device for a photoresist composition comprising the filtration device of the second aspect described above.

A fourth aspect is a photoresist composition produced by the above process for producing a photoresist composition.

A fifth aspect is a process for producing a photoresist composition, comprising the step of passing a photoresist composition, comprising a resin component (A) that satisfies a condition (3) below, an acid generator component (B) that generates acid on exposure, and an organic solvent (C), through a first filter equipped with a first filtration membrane that satisfies a condition (4) below.

(3) The resin component (A) comprises a structural unit (a1) represented by the general formula (I) shown above, and a structural unit (a2) containing an acid dissociable, dissolution inhibiting group.

(4) The first filtration membrane comprises a nylon membrane with a pore size no larger than 0.04 μm.

A sixth aspect is a filtration device comprising a first filtration portion, through which is passed a photoresist composition comprising a resin component (A), an acid generator component (B) that generates acid on exposure, and an organic solvent (C), wherein the filtration device satisfies the conditions (iii) and (iv) described below.

(iii) The first filtration portion comprises a first filter equipped with a first filtration membrane, and this first filtration membrane comprises a nylon membrane with a pore size no larger than 0.04 μm.

(iv) The filtration device is used for filtering a photoresist composition containing a resin component (A) that comprises a structural unit (a1) represented by a general formula (I) shown above, and a structural unit (a2) containing an acid dissociable, dissolution inhibiting group.

A seventh aspect is an application device for a photoresist composition comprising the filtration device described above.

In this description and the appended claims, for the sake of convenience, in the first through fourth aspects, a membrane that satisfies the two aforementioned conditions, namely, a critical surface tension that falls within a specified numerical range, and the absence of charge modification, is termed a first filtration membrane, and a filter equipped with such a membrane is termed a first filter. Furthermore, a membrane that does not satisfy these two specific conditions is termed a second filtration membrane, and a filter equipped therewith is termed a second filter.

In the fifth through seventh aspects, a nylon membrane with a pore size no larger than 0.04 μm is termed a first filtration membrane, and a filter equipped with such a membrane is termed a first filter. Other membranes are termed second filtration membranes, and filters equipped therewith are termed second filters.

Furthermore, in this description and the appended claims, a defect refers to an irregularity that occurs in a resist pattern following developing, and is different from so-called pinhole defects that occur in the resist coating film prior to pattern formation.

In this description, including the appended claims, the term “(meth)acrylic acid” is a generic term describing both methacrylic acid and acrylic acid. Similarly, the term “(meth)acrylate” is a generic term including both acrylate and methacrylate.

The term “structural unit” refers to a unit derived from a monomer that contributes to the formation of a polymer.

A “structural unit derived from a (meth)acrylate” describes a structural unit formed through cleavage of the ethylenic double bond of a (meth)acrylate.

The term “filtration”, as used in relation to the present invention, describes not only the typically accepted chemical meaning of the term (“the passage of only the fluid phase [either gaseous or liquid] through a membrane or phase formed from a porous substance, thus separating a semisolid phase or a solid from the fluid phase”, Encyclopaedia Chimica, vol. 9, issued Jul. 31, 1962, Kyoritsu Shuppan Co., Ltd.), but also those cases where a substance is simply “passed through a filter”, that is, cases where after passage of a substance through a membrane, a semisolid phase or solid material that has been trapped by the membrane may not necessarily be visible.

In the present invention, the photoresist composition passed through a filter may either be a photoresist composition with the same concentration as the final product, or may also be the undiluted solution prior to dilution, which has a solid fraction concentration of 8 to 15% by weight. In this description, unless a specific distinction is made between the undiluted solution and a solution with the same concentration as the final product, then it is assumed that the description also applies to the undiluted solution.

In the present invention, the term application device covers not only typical photoresist composition application devices, but also integrated devices in which the application device is integrated with another device such as a developing device or the like.

Furthermore, in this description, the simplified term “zeta potential” describes the zeta potential in distilled water of pH 7.0. The numerical values presented in the present invention are the nominal values provided by the filter manufacturers.

The present invention provides technology for producing a photoresist composition comprising a so-called hydroxystyrene resin containing hydroxystyrene structural units as the base component, wherein the photoresist composition is capable of suppressing the occurrence of defects, and particularly fine scum and microbridges, in the resist pattern following developing.

Furthermore, the present invention also provides technology for producing a photoresist composition with superior foreign matter characteristics.

Furthermore, the present invention also provides technology for producing a photoresist composition with excellent storage stability as a resist solution.

In addition, the present invention also provides a photoresist composition which forms a resist pattern with excellent resist pattern size stability.

### BRIEF DESCRIPTION OF THE DRAWINGS

FIG. 1 is a schematic illustration showing one example of a filtration device of the present invention.

FIG. 2 is a graph showing a Zisman plot.

FIG. 3 is a schematic illustration showing an example of an application device comprising a filtration device according to the present invention.

### DETAILED DESCRIPTION OF THE INVENTION

### First Embodiment

A production process, a filtration device, an application device, and a photoresist composition according to the aforementioned first through fourth aspects are described below with reference to a first embodiment.

The features of these aspects can provide technology for producing a photoresist composition comprising a so-called hydroxystyrene resin containing hydroxystyrene structural units as the base component, wherein the composition is capable of suppressing the occurrence of defects, and particularly fine scum and microbridges, in the resist pattern following developing.

Furthermore, the features of these aspects also provide technology for producing a photoresist composition with superior foreign matter characteristics.

Furthermore, the features of these aspects also provide technology for producing a photoresist composition with excellent storage stability as a resist solution.

In addition, the features of these aspects also provide a photoresist composition which forms a resist pattern with excellent resist pattern size stability.

[Operational Sequence and Device]

As follows is a description of an example of a filtration device, and a process for producing a photoresist composition, following the sequence of operations.

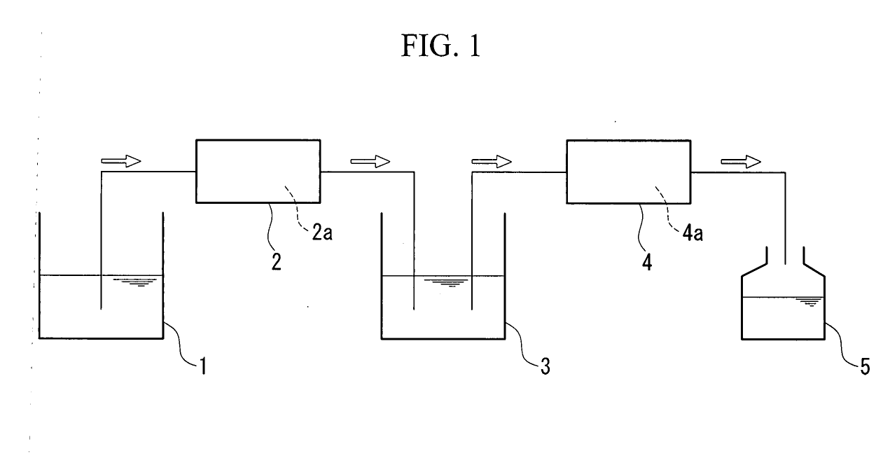

First, as shown in FIG. 1, a filtration device comprising a first filtration portion 2 and a second filtration portion 4 is prepared.

The first filtration portion 2 comprises a first filter 2a equipped with a first filtration membrane.

The first filtration membrane has a critical surface tension of at least 70 dyne/cm, and has not been subjected to charge modification.

The second filtration portion 4 comprises a second filter 4a equipped with a conventional second filtration membrane that differs from the aforementioned first filtration membrane.

Here, the term “filter” describes a structure that comprises at least a filtration membrane through which a photoresist composition can be passed, and a support member for supporting this membrane. Specifically, filter manufacturers such as Nihon Pall, Ltd., Advantec Toyo Co., Ltd., Mykrolis Corporation, and Kitz Corporation produce and market filters formed from a variety of materials and with a variety of pore sizes, for filtering ultra pure water, high-purity pharmaceuticals, and fine chemicals, and these filters are used in the present invention.

In this embodiment, there are no particular restrictions on the shape of the aforementioned first filter 2a and second filter 4a, and either disc filters or cartridge filters can be used.

First Filtration Membrane

By using as the first filtration membrane, a filter comprising a membrane with a critical surface tension of at least 70 dyne/cm, which has not been subjected to charge modification, a reduction in the level of defects, and in particular a suppression of fine scum and microbridges, together with improvements in the foreign matter characteristics and the storage stability as a resist solution can be achieved.

The reasons for these observations are not entirely clear, but ensuring the critical surface tension is at least 70 dyne/cm improves the ease with which the resist composition wets the membrane surface, and it is surmised that this improves the selectivity with which the membrane is able to filter the specific particles likely to cause an increase in defects, or a deterioration in the foreign matter characteristics or in the storage stability as a resist solution.

Furthermore, by ensuring that the membrane has not been subjected to charge modification, charge deviations can be minimized, and it is believed that this suppresses the adsorption of specific substances to the membrane surface, thereby improving the filtration efficiency.

In addition, by using a membrane with the above characteristics as the first filtration membrane, the photoresist composition is less likely to have undergone any change in the composition thereof as a result of passage through the filter, meaning the subsequently formed resist pattern displays excellent size stability. It is surmised that this effect is also a result of the suppression of charge deviations achieved by not subjecting the membrane to charge modification.

The Condition Requiring a Critical Surface Tension of at Least 70 dyne/cm

The critical surface tension is a property that is widely referred to as the “wetting characteristics” of a polymer surface, and refers to the surface tension (yc) of a solid. Unlike a liquid, this yc value cannot be evaluated directly, and is instead determined using the Young-Dupre formula and a Zisman plot.
Young Dupre Formula: γLVcosθ=γSV−γSL

In this formula, θ represents the contact angle, S is a solid, L is a liquid, and V is a saturated vapor. γLV represents the surface tension between a liquid phase and a vapor, γSV represents the surface tension between a solid phase and a vapor, and γSL represents the surface tension between a solid phase and a liquid phase. When water is used as the liquid, θ is 90°, and when θ exceeds 90° the surface is hydrophobic, whereas surfaces in which θ is close to 0° are hydrophilic.

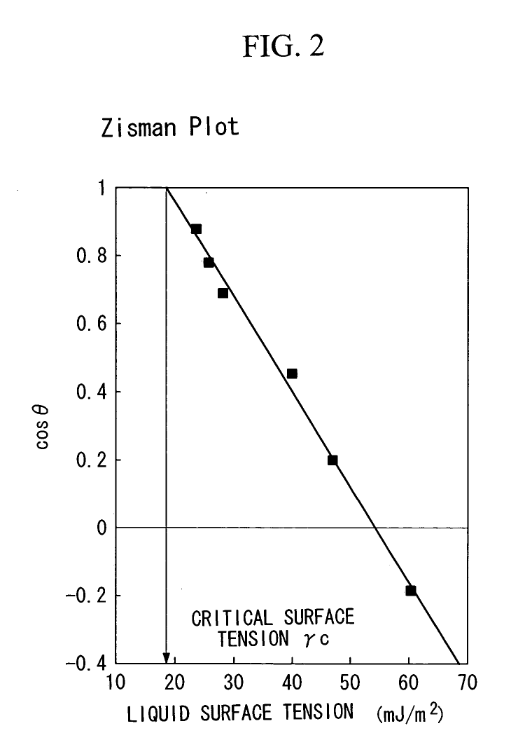

Zisman Plot (see FIG. 2)

Using liquids with a variety of different surface tension values γLV, the contact angle θ is measured, and cos θ is plotted against the value of γLV. As the value of γLV approaches the value of γSV of the solid surface, the value of θ decreases, and at a certain value of γLV, the contact angle θ becomes zero. This value of γLV where θ=0 is defined as the solid surface tension, that is, the critical surface tension (γc).

The membrane used in the filter (the processed membrane for use in the filter) (referred to as the medium), and the original polymer material prior to its use within the filter (prior to being processed for use within the filter) (referred to as the material) have different γc values, as described below.
A sample Nylon 66 (a registered trademark) membrane (medium) installed within a filter: 77 dyne/cm (hereafter the units are omitted)
Nylon 66 (a registered trademark) material prior to installation in a filter: 46
A sample polyethylene or polypropylene membrane (medium) installed within a filter: 36
A sample polytetrafluoroethylene (PTFE) membrane (medium) installed within a filter: 28
Normal PTFE material prior to installation in a filter: 18.5

In this manner, the polymer material (the material), and the membrane formed by processing this material to enable it to function as a filter (the medium) display different γc values.

In this embodiment, the critical surface tension yc refers to the critical surface tension of the first filtration membrane installed in the first filter, and this value must be at least 70 dyne/cm. This numerical restriction does not apply to the original polymer material (the material) used for forming the membrane.

This difference in critical surface tension values between the polymer material and the membrane used within the filter arises as a result of processing of the polymer material to enable its use within the filter.

Even with the same starting material, if the nature of the processing is altered, then the critical surface tension value will also differ, meaning the nominal value for the critical surface tension for a filter membrane is preferably checked to establish a measured value.

By ensuring that the critical surface tension is at least 70 dyne/cm, the level of defects, and in particular the level of fine scum and microbridges, can be reduced, and any deterioration in the foreign matter characteristics or the storage stability as a resist solution can be suppressed.

The upper limit for the critical surface tension is preferably no more than 95 dyne/cm, as higher values can cause a deterioration in the defect reduction effect. Even more preferred values are within a range from 75 to 90 dyne/cm, and the most desirable values are from 75 to 80 dyne/cm.

Simply adopting the nominal value for the critical surface tension provided by the filter manufacturer is the simplest option, although the critical surface tension can also be determined relatively easily by preparing a plurality of liquids with known surface tension values, and then dripping each of these liquids onto the target membrane, and determining the boundary between those liquids that penetrate the membrane under their own weight, and those liquids that do not penetrate.

The Condition Requiring No Charge Modification

Charge modification has the same meaning as the expression forced potential modification.

Furthermore, the existence or absence of charge modification correlates with the zeta potential value, and the phrase “not subjected to charge modification” can also be interpreted as displaying a specific zeta potential in pH 7.0 distilled water.

Zeta Potential

The zeta potential is the electric potential of the diffuse ion layer generated around the periphery of a charged particle in a liquid.

More specifically, if an ultrafine powder displays a charge within a liquid, then an electrical double layer can be formed by oppositely charged ions which are electrostatically attracted to the powder in order to cancel out its charge. The potential at the outermost surface of this electrical double layer is the zeta potential. Measurement of the zeta potential is said to be effective in determining the surface structure of fine powders and fine particles.

As mentioned above, in this description, the simplified term “zeta potential” describes the zeta potential in distilled water of pH 7.0. The numerical values presented in the present invention are the nominal values provided by the filter manufacturers.

A membrane that has not been subjected to charge modification has a zeta potential exceeding −20 mV, but no more than 15 mV. In terms of maximizing the effects of the present invention, the zeta potential is preferably greater than −20 mV, but no more than 10 mV, and even more preferably greater than −20 mV and less than 10 mV, and is most preferably a negative value (although greater than −20 mV).

In the present invention, this negative zeta potential is preferably no more than −5 mV (although greater than −20 mV), and is even more preferably within a range from −18 to −10 mV, and most preferably from −16 to −12 mV.

By employing a membrane with a zeta potential exceeding −20 mV, but no more than 15 mV, and in particular a membrane with a negative zeta potential, the level of defects, and in particular the level of fine scum and microbridges, can be reduced, and the foreign matter characteristics and the storage stability as a resist solution can be improved. Furthermore, if a photoresist composition is filtered through such a membrane, the makeup of the composition displays little variation following filtration, meaning a photoresist composition with excellent resist pattern size stability, which is resistant to variations in sensitivity and the resist pattern size, can be obtained.

In the present invention, in order to satisfy the critical surface tension condition described above, a membrane formed from nylon (polyamide) that has not been subjected to charge modification is preferred.

An example of a filter that satisfies the above critical surface tension value and has not been subjected to charge modification is the ULTIPLEAT P-Nylon filter (product name: manufactured by Nihon Pall, Ltd, zeta potential: approximately −16 to −12 mV, pore size: 0.04 μm, critical surface tension: 77 dyne/cm), which is manufactured from nylon 66.

Furthermore, examples of filters that do not satisfy the above critical surface tension value include conventional, commercially available filters equipped with a membrane formed from a fluororesin such as PTFE or a polyolefin resin such as polypropylene or polyethylene.

The critical surface tension value for the membrane of these filters is typically no more than 50 dyne/cm.

Pore Size of First Filtration Membrane

The pore size of the membrane used in the first filter can be set to a value within the desired range based on the nominal pore size value provided by the filter manufacturer.

By suitable combinations of the filter portions (the form of the filter, the nature of the membrane, and the number of times the composition is passed through any particular membrane), the following types of adjustments can be made in terms of productivity and altering the effects of the present invention.

i)-1 Example 1 Filtration Conducted Using only a First Filter

This example represents the case where filtration is conducted using only the first filter, and other filters such as the second filter 4a shown in FIG. 1 are not used.

In this case, using a first filter in which the pore size of the membrane is no more than 0.2 μm, and preferably no more than 0.1 μm, and even more preferably no more than 0.04 μm, is preferable in terms of the effects achieved.

However, if the pore size becomes overly small, then the productivity (the throughput for the production and application of the resist composition) tends to fall. The lower limit for the pore size is 0.01 μm, although from a practical viewpoint, the pore size is typically at least 0.02 μm.

(ii)-2 Example 2 Filtration Conducted Using a Combination of a First Filter and Another Filter

In this case, using a first filter in which the pore size of the membrane is no more than 0.2 μm, and preferably no more than 0.1 μm, and even more preferably no more than 0.04 μm, is preferable in terms of the effects achieved. The lower limit for this pore size is 0.01 μm, although from a practical viewpoint, the pore size is typically at least 0.02 μm.

In both the example 1 and the example 2, using a first filter in which the pore size of the membrane falls within a range from 0.01 to 0.1 μm, and preferably from 0.01 to 0.04 μm, and even more preferably from 0.02 to 0.04 μm, is preferred in terms of the defect reduction effect, the improvement in both the foreign matter characteristics and the storage stability as a resist solution, and the productivity.

In terms of the best balance between the effects achieved and the productivity, a pore size of 0.04 μm is preferred.

Second Filtration Membrane

The second filtration membrane can use any membrane typically used in the filtration of photoresist compositions, and there are no particular restrictions.

Examples of suitable membranes include those formed from fluororesins such as PTFE (polytetrafluoroethylene), polyolefin resins such as polypropylene and polyethylene, and polyamide resins such as nylon 6 (a registered trademark) and nylon 66 (a registered trademark).

Of these, membranes formed from polypropylene or polyethylene are preferred, as compared with the other membranes, they produce a superior defect reduction effect and superior storage stability as a resist solution when combined with the first filter. Membranes formed from polypropylene include not only those of normal polypropylene, but also membranes formed from high density polypropylene and ultra high molecular weight polypropylene.

Pore Size of the Second Filtration Membrane

The pore size of the membrane of the second filer is typically no more than 0.2 μm, and preferably no more than 0.1 μm, and most preferably no more than 0.02 μm. There are no particular restrictions on the lower limit for the pore size, although from a practical viewpoint, the pore size is typically at least 0.02 μm.

Membrane pore sizes for the second filter that fall within the range from 0.02 to 0.1 μm are preferred in terms of the defect reduction effect, and the improvement in both the foreign matter characteristics and the storage stability as a resist solution.

As above, the pore sizes for the second filters refer to the nominal values provided by the filter manufacturers.

As well as preparing this type of filtration device, a photoresist composition comprising a resin component (A), an acid generator component (B) that generates acid on exposure, and an organic solvent (C) is also prepared using normal methods.

As the component (A), a resin comprising a structural unit (a1) represented by the above general formula (I), and a structural unit (a2) containing an acid dissociable, dissolution inhibiting group is used. Details relating to the component (A) are described below.

Subsequently, as shown in FIG. 1, the photoresist composition is supplied from a storage tank 1 (a storage portion for the photoresist composition) to the first filtration portion 2, and the photoresist composition then passes through, and is filtered by, a first filtration membrane in the first filter 2a provided inside the first filtration portion 2. The resulting filtrate flows into a first filtrate storage tank 3.

The filtrate (the photoresist composition) is then supplied from the first filtrate storage tank 3 to the second filtration portion 4, where the filtrate passes through, and is filtered by, a second filtration membrane in the second filter 4a provided inside the second filtration portion 4.

Finally, the resulting filtrate (the photoresist composition) enters a container 5 as a final product.

The respective surface areas (filtration surface areas) of the first filter 2a and the second filter 4a are preferably adjusted in accordance with factors such as the quantity of photoresist composition requiring treatment. There are no particular restrictions on these values, and conventionally used conditions are appropriate.

Similarly, there are also no particular restrictions on the filtration pressure (differential pressure resistance) for the first filter 2a and the second filter 4a, and conventionally used conditions are appropriate.

Furthermore, the flow rate with which the photoresist composition is supplied to the first filtration portion 2 and the second filtration portion 4 can be suitably adjusted in accordance with factors such as the filter characteristics and the filtration surface area, although conventional flow rates are typically used.

In the present invention, filtration must be conducted at least once using the first filter, and this enables a reduction in the level of defects, and provides superior performance in terms of foreign matter characteristics and storage stability as a resist solution. There are no other particular restrictions in terms of factors such as the number of times the composition is passed through a single filter (the filtration repetitions), or the combination that is employed with other filters equipped with different types of filtration membranes, and these factors can be suitably adjusted as required.

Accordingly, other than the filtration operation performed by the first filter 2a shown in FIG. 1, no further filtration is absolutely necessary. However, conducting additional filtration to that performed by the first filter 2a, such as that performed by the second filter 4a described above, is preferred, as it reduces the filtration burden on the first filter 2a, and enables further improvements in the defect reduction effect, the foreign matter characteristics, and the storage stability as a resist solution.

Examples of the different combination sequences possible between filtration by the first filter and filtration by another filter (such as filtration by the second filter) include those described below. These combinations are described together with the sequence shown in FIG. 1.

The configuration of the filtration device can be selected in accordance with the particular combination of filters used for filtration. For example, by providing suitable storage portions such as storage tanks for holding the photoresist composition prior to, and following filtration by either one, or two or more filters (filtration portions), a variety of different configurations can be produced.

Furthermore, in those cases where filtration is performed more than once using the same filter, normal methods can be used to easily establish a configuration in which the treatment target liquid is supplied to the filter, and the resulting filtrate is then circulated and passed through the same filter a second time.

(i)-1 Sequence Example 1 (post-filtration): Following filtration by the first filter, post-filtration is conducted using another filter different from the first filter.

This example 1 includes the sequence shown in FIG. 1.

In this example, there are no restrictions on the number of repetitions of filtration performed by the first filter, and this number is typically 1 or 2 repetitions.

Similarly, there are also no restrictions on the number of repetitions of post-filtration performed by the other filter different from the first filter, and this number is also typically 1 or 2 repetitions.

The filter membrane used during the post-filtration step can employ the type of membrane described above in relation to the second filter membrane, and is preferably formed from polypropylene or polyethylene, for the reasons outlined above.

This post-filtration preferably involves a first filtration through a filter equipped with a polyethylene or polypropylene membrane, followed by a second filtration through a filter equipped with a PTFE membrane. Filtration using only the filter equipped with a polyethylene or polypropylene membrane is also acceptable, although using an additional filtration through a filter equipped with a PTFE membrane further improves the effects of the present invention, and is consequently preferred.

(i)-2 Sequence Example 2 (pre-filtration): Following one or two repetitions of pre-filtration using a filter different from the first filter, filtration is conducted using the first filter.

In this example, as in the example above, there are no restrictions on the number of repetitions of filtration performed by the first filter, and this number is typically 1 or 2 repetitions.

Similarly, there are also no restrictions on the number of repetitions of pre-filtration performed by the other filter different from the first filter, and this number is also typically 1 or 2 repetitions.

The filter membrane used during the pre-filtration step can employ the type of membrane described above in relation to the second filter membrane, and is preferably formed from polypropylene or polyethylene, for the reasons outlined above.

This pre-filtration preferably involves a first filtration through a filter equipped with a PTFE membrane, followed by a second filtration through a filter equipped with a polyethylene or polypropylene membrane. Filtration using only the filter equipped with a polyethylene or polypropylene membrane is also acceptable, although using a combination that provides an additional filtration through a filter equipped with a PTFE membrane further improves the effects of the present invention, and is consequently preferred.

(i)-3 Sequence Example 3

The post-filtration of the above example 1 and the pre-filtration of the example 2 can also be combined.

Preferred configurations for this combination are simply a combination of the configurations described above in the examples 1 and 2.

Of the above, the most preferred filtration sequence in terms of the effects achieved is the sequence described below.

(ii)-1 Preferred Configuration: Filtration is Conducted Once or Twice Using the First Filter, and then a Final Filtration is Performed Using a Second Filter Formed from Polyethylene or Polypropylene.

This operation provides a superior defect reduction effect, as well as excellent foreign matter characteristics and storage stability as a resist solution.

Configuration of the Filtration Device

As the filtration device, a variety of different configurations can be employed.

For example, the type of device shown in FIG. 1, which represents a device used in the production of a typical photoresist composition, can be used, or a device that is installed within an application device such as a spinner, or an application and developing device (a coater-developer), can also be used.

In other words, in the present invention, an application device incorporating a filtration device of the present invention includes not only typical photoresist application devices, but also includes integrated devices such as coater-developers, wherein the application device is integrated with another device such as a developing device or the like.

Application Device

This type of application device comprises a nozzle, and typically supplies the photoresist composition from this nozzle onto the surface of a wafer (substrate), thereby coating the wafer with the photoresist composition.

Accordingly, if a filtration device of the present invention is built into the application device, so that prior to being supplied from the nozzle to the wafer, the photoresist composition passes through the membrane or membranes of the filtration device, then those substances within the photoresist composition that are likely to either cause defects, or cause a deterioration in the foreign matter characteristics or the storage stability as a resist solution, can be removed prior to the photoresist composition being supplied to the wafer. As a result, the level of defects, and in particular the level of fine scum and microbridges, can be reduced, and a superior level of resist pattern size stability can be achieved.

When designing an application device, the filter should preferably be removable from the application device. In other words, in an application device comprising a filtration device, a structure in which the filter can be detached and replaced independently is preferred.

Specific Example of the Application Device

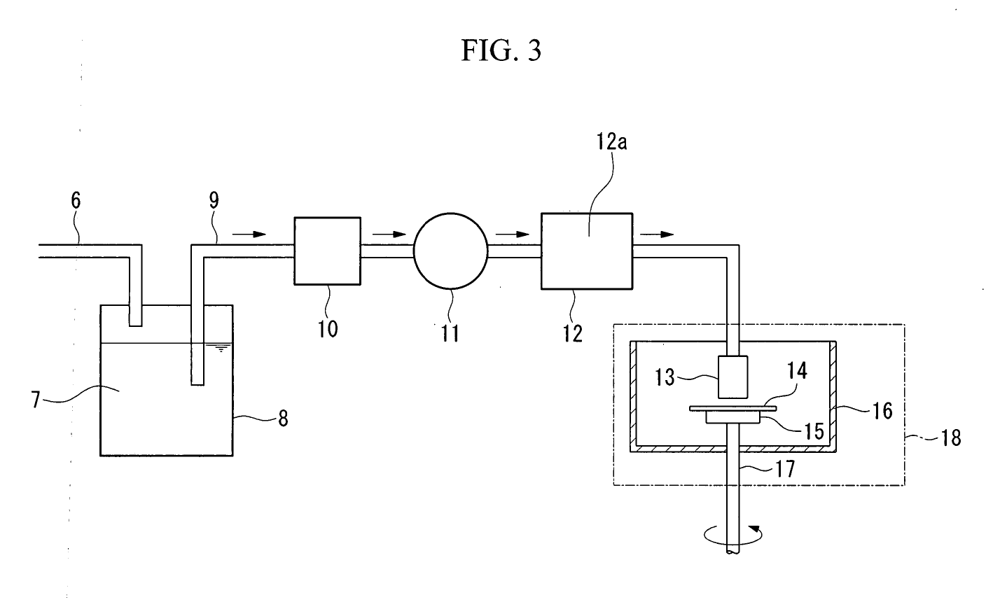

FIG. 3 is a schematic illustration showing an example of the application device.

In this device, a photoresist composition 7 is drawn from a reservoir tank 10 using a pump 11, passes through an inlet pipe 9, is passed through a first filtration portion 12, and is then supplied onto a substrate 14 such as a silicon wafer from a nozzle 13 of the application device. Filtration of the composition is conducted by a first filtration membrane of a first filter 12a, which is provided inside the first filtration portion 12.

A pressurization pipe 6 is provided in a storage portion 8, and by pressurizing the photoresist composition 7 stored inside the storage portion 8 using an inert gas such as nitrogen, the photoresist composition 7 can be supplied from the storage portion 8 to the reservoir tank 10.

Subsequently, the filtered composition is dripped from the nozzle 13. During this process, by rotating a rotational axis 17 provided inside the application portion 18 of the application device, a substrate support portion 15 provided at the tip of the rotational axis 17 can be used to rotate the substrate 14 positioned on top of this support portion 15. The resulting centrifugal force causes the photoresist composition dripped onto the substrate 14 to spread outwards, thereby coating the surface of the substrate 14.

A cylindrical body with a bottom 16 (a protective wall) is provided which encloses the nozzle 13, the substrate 14, and the support portion 15, and the rotational axis 17 passes through the bottom of this cylindrical body. The closed cylindrical body 16 with a bottom prevents the photoresist composition from being splattered over the surrounding area during rotation of the substrate.

The reservoir tank 10 may be either included or excluded, and there are no particular restrictions on the pump 11, provided it is capable of supplying the photoresist composition from the storage portion 8 to the application portion 18.

Furthermore, the second filtration portion comprising the second filter can be provided either prior to, and/or after the first filtration portion 12, and the specific combination of filters can be selected as desired from a variety of possible configurations.

In the above description, a spinner was described as one example of the application device, although in recent years, a variety of non-rotational application methods such as the slit nozzle method have been proposed, and these can also be employed.

Furthermore, as described above, the application device may also be a coater-developer type device in which the subsequent developing step is also conducted within the one device. An example of this type of device is the Clean Track ACT-8 (product name), manufactured by Tokyo Electron Co., Ltd.

Photoresist Composition

A photoresist composition of this embodiment is produced using the production process of the present embodiment, and displays minimal scum or microbridge occurrence within the resist pattern, as well as excellent foreign matter characteristics, storage stability as a resist solution, and resist pattern size stability.

In terms of evaluating the characteristics of the photoresist composition, resist pattern defects can be evaluated in terms of the number of so-called surface defects, which can be detected using a surface defect inspection apparatus KLA2132 (product name) manufactured by Tencor Corporation. Furthermore, a determination as to whether a defect is scum or a microbridge can be made on the basis of observation of the pattern surface using a measuring SEM (scanning electron microscope) or the like.

The foreign matter characteristics and the storage stability as a resist solution can be evaluated by using a particle counter to measure the number of foreign matter particles.

The foreign matter characteristics are measured by using a liquid particle counter (product name: Particle Sensor KS-41 or KL-20K, manufactured by Rion Co., Ltd.) to measure the photoresist composition immediately following completion of the filtration treatment.

The storage stability as a resist solution is evaluated by observing samples of the photoresist composition that have been stored in a freezer, a refrigerator, or at room temperature (25° C.).

In such a device, the number of particles with a particle size within a range from 0.15 μm to 0.3 μm or greater is counted per 1 cm³ of composition. The measurement limit is typically 20,000 particles/cm³ or greater. Specifically, the aforementioned Particle Sensor KS-41 can be used to measure the number of particles of particle size 0.15 μm or greater.

Typically, the measured value of foreign matter particles of particle size 0.15 μm or greater within a photoresist composition immediately following filtration treatment in accordance with the present invention (this does not include the undiluted solution) can be reduced to a value of no more than 80 particles/cm³, and even to a value of no more than 50 particles/cm³.

Furthermore, even after 6 months storage, whether in a freezer, a refrigerator, or at room temperature, the storage stability as a resist solution of preferable embodiment of the resist composition of the present invention is such that the measured value of foreign matter particles is little changed from the value immediately following filtration.

The occurrence of defects such as scum and microbridges is also minimal.

Furthermore, in a process for producing a photoresist composition according to the present invention, the makeup of the photoresist composition undergoes no change during the filtration treatment.

An evaluation of whether or not the makeup of the photoresist composition changes with filtration can be performed by analyzing and comparing the respective concentration values for the materials within the photoresist composition prior to, and then following, passage through the filter, and by measuring any changes in the sensitivity (optimum exposure dose) or the resist pattern size when forming a resist pattern using the photoresist composition.

### Second Embodiment

A production process of the aforementioned fifth aspect, a filtration device of the sixth aspect, and an application device of the seventh aspect are described below with reference to a second embodiment.

[Operational Sequence and Device]

The difference between the second embodiment and the first embodiment is that the second embodiment employs a first filter 2a comprising a nylon membrane with a pore size no larger than 0.04 μm as the first filtration portion 2 shown in FIG. 1.

By using a first filter equipped with a first filtration membrane formed from a nylon membrane with a pore size no larger than 0.04 μm, a reduction in the level of defects, and in particular a suppression of fine scum and microbridges, and improvements in both the foreign matter characteristics and the storage stability as a resist solution can be achieved.

The reasons for these observations are not entirely clear, but it is surmised that using a nylon membrane that satisfies the characteristics for the first filtration membrane, and setting a specific pore size enables the membrane surface to selectively adsorb low molecular weight materials likely to cause an increase in defects or foreign matter, thereby improving the filtration efficiency.

In this description, the term nylon is used to describe polyamides with an aliphatic backbone, and suitable examples include nylon 66 and nylon 6.

An example of a filter with a membrane that satisfies the above conditions is the ULTIPLEAT P-Nylon filter (product name: manufactured by Nihon Pall, Ltd, zeta potential: approximately −16 to −12 mV, pore size: 0.04 μm, critical surface tension: 77 dyne/cm), which is manufactured from nylon 66.

In a preferred form of this second embodiment, the nylon membrane used in the filter does not incorporate general nylon 66 (material), which does not display the characteristics of the first filtration membrane (namely, a critical surface tension of at least 70 dyne/cm, and an absence of charge modification) described for the first embodiment. Accordingly, nylon 66 (material) with a critical surface tension of 46 dyne/cm does not correspond with the nylon membrane in the filter.

The pore size of the first filtration membrane used in the first filter 2a refers to the nominal value provided by the filter manufacturer.

In the present invention, and particularly in this embodiment, the filtration differs somewhat from the general understanding of the term, which suggests that smaller pore sizes will result in an improved defect reduction effect, and improved foreign matter characteristics and storage stability as a resist solution. As a result, the membrane and pore size are preferably selected with due consideration given to the relationship between the membrane size and the membrane material.

For example, not only in those cases where a second filter is not used, and filtration is conducted solely through the first filter, but also in those cases where a combination with a second filter is employed, the membrane within the first filter of the present embodiment uses a product with a pore size no larger than 0.04 μm.

If the pore size becomes overly small, then the productivity (the throughput for the production and application of the resist composition) tends to fall. The lower limit for the pore size is 0.01 μm, although from a practical viewpoint, the pore size is typically at least 0.02 μm. By ensuring that the pore size is no larger than 0.04 μm, a reduction in the level of defects, and in particular a suppression of fine scum and microbridges, and improvements in both the foreign matter characteristics and the storage stability as a resist solution can be achieved.

As described above, the effects provided by this numerical restriction are achieved through a combination with a nylon membrane.

In the second embodiment, the first filtration membrane must satisfy the above condition, and has preferably also not been subjected to charge modification.

Here, charge modification has the same meaning as that described in relation to the first embodiment, and the preferred form of this embodiment is similar to the aforementioned first embodiment in terms of charge modification.

This enables a further improvement in the effects of the invention. Furthermore, filtration treatment of the photoresist composition causes little variation in the sensitivity and resist pattern size following treatment, which is very desirable.

In this second embodiment, with the exception of the point of difference from the first embodiment, a preferred form of the embodiment is the same as that described for the first embodiment.

This second embodiment enables the production of a photoresist composition with similar qualities to a composition obtained in the first embodiment.

[Composition of Photoresist Compositions Suited to application of the Present Invention]

The present invention is suited to the production of so-called chemically amplified photoresist compositions, containing a resin component and an acid generator as essential components. In other words, a production process of the present invention is ideally suited to the treatment of this type of photoresist composition, and a filtration device and application device of the present invention are ideally suited to the treatment of photoresist compositions containing these types of components.

There are no particular restrictions on the aforementioned component (A), and any material typically used in chemically amplified photoresist compositions can be employed, although materials that are ideal as the resin component for photoresist compositions for use with KrF excimer lasers are particularly preferred.

Similarly, application of the present invention to processes and devices that use resists for use with KrF excimer lasers is preferred.

Component (A)

The component (A) is the base component for formation material of a coating film comprising the photoresist composition.

The component (A) is an alkali-insoluble material containing a so-called acid dissociable, dissolution inhibiting group, and when acid is generated from the component (B) on exposure, this acid causes the acid dissociable, dissolution inhibiting group to dissociate, causing the component (A) to change to an alkali soluble state.

As follows is a description of a preferred form of the component (A) of a photoresist composition applicable to the present invention.

Firstly, the component (A) must comprise an aforementioned structural unit (a1), and a structural unit (a2) containing the acid dissociable, dissolution inhibiting group.

Structural Unit (a1)

The structural unit (a1) is represented by the above general formula (I). In the general formula (I), R represents a hydrogen atom or a methyl group, although a hydrogen atom is preferred. The bonding position of the hydroxyl group may be the o-position, the m-position or the p-position, although from the viewpoints of availability and cost, the p-position is preferred. m represents an integer from 1 to 3, although a value of 1 is preferred.

The structural unit (a1) preferably accounts for 40 to 80 mol %, and even more preferably from 50 to 75 mol % of the component (A). Ensuring that the proportion of the structural unit (a1) is at least 40 mol % enables an improvement in the solubility within the alkali developing solution, and also provides an improved pattern shape. Ensuring that the proportion is no more than 80 mol % enables a more favorable balance with other structural units.

Structural Unit (a2)

As the structural unit (a2), a large variety of different units have been proposed, and any of these structural units may be selected and used.

Suitable examples of the principal chain of the structural unit (a2) include a (meth)acrylic acid backbone, or a hydroxystyrene backbone represented by the aforementioned general formula (I).

In the case of a (meth)acrylic acid backbone, specific examples include structural units containing structures in which the ethylenic double bond of the (meth)acrylic acid has been cleaved, and the hydrogen atom of the carboxyl group has been replaced with an acid dissociable, dissolution inhibiting group [that is, —C(O)—O—R′, wherein R′ represents an acid dissociable, dissolution inhibiting group] [in other words, structural units derived from (meth)acrylic acid, and containing an acid dissociable, dissolution inhibiting group].

In the case of a hydroxystyrene backbone, structural units in which the hydrogen atom of the hydroxyl group in the above general formula (I) has been substituted with an acid dissociable, dissolution inhibiting group can be used.

As the acid dissociable, dissolution inhibiting group, groups such as alkoxyalkyl groups, tertiary alkoxycarbonyl groups, tertiary alkyl groups, cross-linking groups represented by a general formula (2) shown below, and cyclic acetal groups can be used. Of these, tertiary alkyl groups are preferred.

The backbone for the principal chain may be appropriately selected in accordance with factors such as the nature of the acid dissociable, dissolution inhibiting group.

For example, in the case of a (meth)acrylic acid backbone, tertiary alkyl groups, the above cross-linking groups, and cyclic acetal groups are mainly used. In the case of a hydroxystyrene backbone represented by the above general formula (I), alkoxyalkyl groups, tertiary alkoxycarbonyl groups, tertiary alkyl groups, the above cross-linking groups, and cyclic acetal groups and the like can be used.

Of the possible structural units (a2), structural units in which the principal chain is a (meth)acrylic acid backbone can be represented by the general formula shown below. 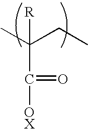
(wherein, R represents a hydrogen atom or a methyl group, and X represents an acid dissociable, dissolution inhibiting group)

Provided the group R is either a hydrogen atom or a methyl group there are no other particular restrictions.

The acid dissociable, dissolution inhibiting group X is, for example, an alkyl group with a tertiary carbon atom, wherein the tertiary carbon atom of the tertiary alkyl group is bonded to the ester group (—C(O)O—) (namely, a tertiary alkyl group); or a cyclic acetal group such as a tetrahydropyranyl group or a tetrahydrofuranyl group.

This acid dissociable, dissolution inhibiting group X can also use other groups typically used in chemically amplified positive photoresist compositions, although a tertiary alkyl group is preferred. In other words, a structural unit (a2-1) derived from (meth)acrylic acid, in which the acid dissociable, dissolution inhibiting group is a tertiary alkyl group, is preferred.

Preferred examples of this structural unit (a2-1) include the structural units represented by the general formula (1) shown below.

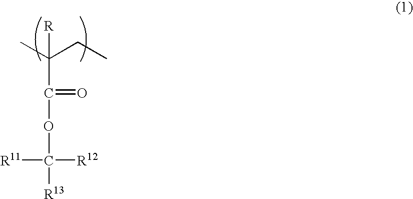

In this formula, R is as defined above, and R¹¹, R¹², and R¹³ each represent, independently, a lower alkyl group (which may comprise either a straight chain or a branched chain, but preferably contain from 1 to 5 carbon atoms). Alternatively, two of the groups R¹¹, R¹², and R¹³ may be bonded together, forming a monocyclic or polycyclic alicyclic group (and preferably a cycloalkyl group). The number of carbon atoms within such an alicyclic group is preferably within a range from 5 to 12 atoms. In those cases where two of the groups R¹¹, R¹², and R¹³ are bonded together to form a cyclic group, the remaining group is a lower alkyl group (which may comprise either a straight chain or a branched chain, but preferably contains from 1 to 5 carbon atoms).

In those cases where the structural unit does not contain a cyclic group, a tert-butyl group in which all of R¹¹, R¹², and R¹³ are methyl groups [that is, a structural unit derived from tert-butyl (meth)acrylate] is preferred.

In those cases where the structural unit contains an alicyclic group, if the alicyclic group is a monocyclic group, then preferred cyclic groups include a cyclopentyl group and a cyclohexyl group.

Furthermore, of structural units containing a polycyclic alicyclic group, structural units represented by the general formulas shown below are preferred. 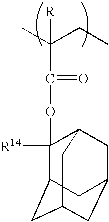
[wherein, R is as defined above, and R¹⁴ represents a lower alkyl group (which may comprise either a straight chain or a branched chain, but preferably contains from 1 to 5 carbon atoms)] 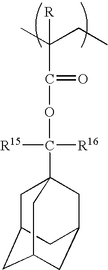
[wherein, R is as defined above, and R¹⁵ and R¹⁶ each represent, independently, a lower alkyl group (which may comprise either a straight chain or a branched chain, but preferably contain from 1 to 5 carbon atoms)]

In those cases where the structural unit (a2) contains an acid dissociable, dissolution inhibiting group, and a hydroxystyrene backbone, structural units which have been rendered alkali insoluble by substituting at least one, and preferably all, of the hydrogen atoms of the hydroxyl groups within the structural unit represented by the above general formula (I) with acid dissociable, dissolution inhibiting groups are preferred.

Preferred examples of these structural units containing a hydroxystyrene backbone include those represented by the general formula shown below. 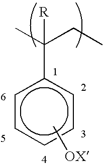
(wherein, R represents a hydrogen atom or a methyl group, and X′ represents an acid dissociable, dissolution inhibiting group)

The acid dissociable, dissolution inhibiting group X′ can use any of the groups typically used in chemically amplified positive photoresist compositions, including different groups from those described above.

Specific examples of the acid dissociable, dissolution inhibiting group X′ include tertiary alkyloxycarbonyl groups such as tert-butyloxycarbonyl groups and tert-amyloxycarbonyl groups; tertiary alkyloxycarbonylalkyl groups such as tert-butyloxycarbonylmethyl groups and tert-butyloxycarbonylethyl groups; tertiary alkyl groups such as tert-butyl groups and tert-amyl groups; cyclic acetal groups such as tetrahydropyranyl groups and tetrahydrofuranyl groups; and alkoxyalkyl groups such as ethoxyethyl groups and methoxypropyl groups.

Of these groups, tert-butyloxycarbonyl groups, tert-butyloxycarbonylmethyl groups, tert-butyl groups, tetrahydropyranyl groups, and ethoxyethyl groups are preferred.

There are no particular restrictions on the bonding position of the group (OX′) to the benzene ring, although the para-position (the 4-position) is preferred.

In the structural unit (a2), the acid dissociable, dissolution inhibiting group may also be a cross-linking group represented by a general formula (2) shown below. 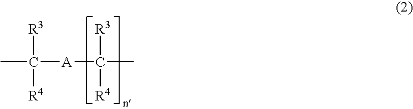
(wherein R³ and R⁴ each represent, independently, a lower alkyl group, n′ represents an integer from 1 to 3, and A represents either a single bond, or an organic group with a valency of n′+1.

The cross-linking group is a group that preferably links 2 or 3 structural units containing carboxyl groups or hydroxyl groups or the like.

Examples of the lower alkyl groups of R³ and R⁴ (which preferably contain no more than 5 carbon atoms) include methyl groups, ethyl groups, n-propyl groups, isopropyl groups, n-butyl groups, isobutyl groups, tert-butyl groups, and n-pentyl groups.

Furthermore, A represents either a single bond, or an organic group with (n′+1) bonding arms, and is preferably a hydrocarbon group of 1 to 20 carbon atoms.

Examples of suitable hydrocarbon groups in those cases where n′ is 1 include straight chain or branched alkylene groups, cycloalkylene groups, or arylene groups, whereas examples of suitable hydrocarbon groups in those cases where n′ is 2 include similar alkylene groups, cycloalkylene groups, or arylene groups in which one hydrogen atom has been eliminated to generate a trivalent group.

Furthermore, examples of suitable hydrocarbon groups in those cases where n′ is 3 include similar alkylene groups, cycloalkylene groups, or arylene groups in which two hydrogen atoms have been eliminated to generate a tetravalent group.

Particularly preferred examples of the above cross-linking group include groups in which A is a straight chain alkylene group of 2 to 10 carbon atoms, and R³ and R⁴ are both methyl groups.

There are no particular restrictions on the principal chain structure of the structural units that are linked by the above cross-linking group, and both hydroxystyrene structural units with similar structures to the structural unit (a1) described above, and the aforementioned structural units with a (meth)acrylic acid backbone are suitable, although structural units with a (meth)acrylic acid backbone are preferred.

In other words, cross-linked structures such as those represented by the general formula shown below are preferred. 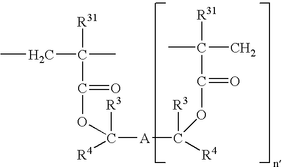
(wherein, R³¹ is a methyl group or a hydrogen atom, and R³, R⁴, n′, and A are as defined above)

In a preferred cross-linked structure, at least two acrylic acid or methacrylic acid tertiary alkyl esters are linked via an organic group formed at one of the alkyl groups bonded to each of the tertiary carbon atoms of the esters. With such a structure, the action of the acid generated during exposure causes the ester groups to be converted to carboxyl groups, thereby causing the resin component within the exposed portions to change to an alkali soluble state. In contrast, in the unexposed portions, the cross-linking group remains, meaning the alkali insolubility of the resin component is retained.

These types of cross-linked structures are derived from diesters, triesters, or tetraesters comprising from 2 to 4 ethylenic unsaturated bonds, produced by bonding from 2 to 4 molecules of acrylic acid, methacrylic acid, or a reactive functional derivative thereof such as an acid halide, to a single molecule of an alcohol with 2 to 4 hydroxyl groups, such as a diol, triol, or tetraol comprising a tertiary carbon atom with a hydroxyl group bonded to each of the terminals.

Examples of the above diol include glycols such as 2,3-dimethyl-2,3-butanediol, 2,3-diethyl-2,3-butanediol, 2,3-di-n-propyl-2,3-butanediol, 2,4-dimethyl-2,4-pentanediol, 2,4-diethyl-2,4-pentanediol, 2,4-di-n-propyl-2,4-pentanediol, 2,5-dimethyl-2,5-hexanediol, 2,5-diethyl-2,5-hexanediol, 2,5-di-n-propyl-2,5-hexanediol, 2,6-dimethyl-2,6-heptanediol, 2,6-diethyl-2,6-heptanediol, and 2,6-di-n-propyl-2,6-heptanediol; examples of the above triol include 2,4-dimethyl-2,4-dihydroxy-3-(2-hydroxypropyl)pentane, 2,4-diethyl-2,4-dihydroxy-3-(2-hydroxypropyl)pentane, 2,5-dimethyl-2,5-dihydroxy-3-(2-hydroxypropyl)hexane, and 2,5-diethyl-2,5-dihydroxy-3-(2-hydroxypropyl)hexane; and examples of the above tetraol include erythritol, pentaerythritol, and 2,3,4,5-hexanetetraol.

Amongst these diesters and triesters, particularly preferred structures include diesters represented by a general formula shown below: 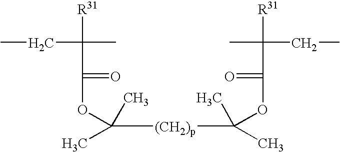
(wherein, R³¹ is as defined above, and p is 0, 1, or 2), and triesters represented by either of the general formulas shown below: 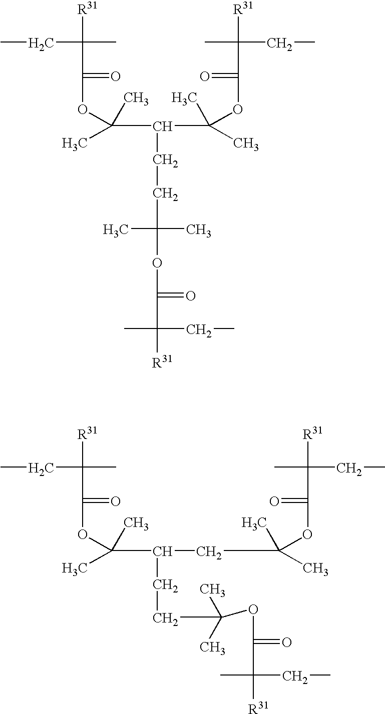
(wherein, R³¹ is as defined above).

The structural unit (a2) preferably accounts for 1 to 30 mol %, and even more preferably from 2 to 10 mol % of the component (A). Ensuring that the proportion of the structural unit (a2) is at least 1 mol % enables the solubility characteristics in the alkali developing solution to be changed. Ensuring that the proportion is no more than 30 mol % enables a more favorable balance with other structural units.

The component (A) may also comprise other structural units, in addition to the essential structural units (a1) and (a2).

These other structural units are preferably the type of structural unit (a3) described below.

Structural Unit (a3)

The structural unit (a3) is represented by a general formula (II) shown below. 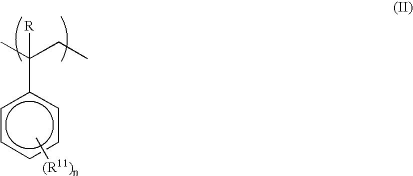
(wherein, R represents a hydrogen atom or a methyl group, R¹¹ represents a lower alkyl group, and n represents either 0, or an integer from 1 to 3)

The lower alkyl group of the group R¹¹ may comprise either a straight chain or a branched chain, although the number of carbon atoms is preferably within a range from 1 to 5 atoms. n represents either 0, or an integer from 1 to 3, but is preferably 0.

In those cases where a structural unit (a3) is used, the structural unit (a3) typically accounts for 1 to 40 mol %, and preferably from 5 to 25 mol % of the component (A). Ensuring that the proportion of the structural unit (a3) is at least 1 mol % tends to increase the level of improvement in the resist pattern shape (and particularly improves the thickness loss described below). Ensuring that the proportion is no more than 40 mol % enables a more favorable balance with other structural units.

Of the possible compositions of the component (A), components comprising the structural unit (a1), a structural unit (a2-1) derived from (meth)acrylic acid, in which the acid dissociable, dissolution inhibiting group is a tertiary alkyl group, as the structural unit (a2), and a structural unit (a3) represented by the above general formula (II) are preferred. Of such resins, components comprising the structural unit (a1), the above structural unit (a2-1) in which the acid dissociable, dissolution inhibiting group is a tert-butyl group as the structural unit (a2), and a structural unit (a3) represented by the above general formula (II) are particularly preferred.

The component (A) need only comprise the essential structural units (a1) and (a2) described above. For example, the component (A) may be a copolymer, or a mixed resin comprising a plurality of different resin components, although a copolymer is preferred.

The component (A) can be used either singularly, or in combinations of two or more different resins.

The polystyrene equivalent weight average molecular weight determined using GPC (gel permeation chromatography) is typically greater than 2000, and preferably within a range from 3000 to 30,000, and even more preferably from 5000 to 20,000

(B) Compound that Generates Acid on Exposure

In the present invention, the component (B) can use any of the known acid generators typically used in conventional chemically amplified resist compositions, without any particular restrictions. Examples of such acid generators are numerous, and include onium salt-based acid generators such as iodonium salts and sulfonium salts, oxime sulfonate-based acid generators, diazomethane-based acid generators such as bisalkyl or bisaryl sulfonyl diazomethanes, and diazomethane nitrobenzyl sulfonates, iminosulfonate-based acid generators, and disulfone-based acid generators.

Specific examples of suitable onium salt-based acid generators include diphenyliodonium trifluoromethanesulfonate or nonafluorobutanesulfonate, bis(4-tert-butylphenyl)iodonium trifluoromethanesulfonate or nonafluorobutanesulfonate, triphenylsulfonium trifluoromethanesulfonate, heptafluoropropanesulfonate or nonafluorobutanesulfonate, tri(4-methylphenyl)sulfonium trifluoromethanesulfonate, heptafluoropropanesulfonate or nonafluorobutanesulfonate, dimethyl(4-hydroxynaphthyl)sulfonium trifluoromethanesulfonate, heptafluoropropanesulfonate or nonafluorobutanesulfonate, monophenyldimethylsulfonium trifluoromethanesulfonate, heptafluoropropanesulfonate or nonafluorobutanesulfonate, and diphenylmonomethylsulfonium trifluoromethanesulfonate, heptafluoropropanesulfonate or nonafluorobutanesulfonate.

Specific examples of suitable oxime sulfonate-based acid generators include □-(methylsulfonyloxyimino)-phenylacetonitrile, □-(methylsulfonyloxyimino)-p-methoxyphenylacetonitrile, □-(trifluoromethylsulfonyloxyimino)-phenylacetonitrile, □-(trifluoromethylsulfonyloxyimino)-p-methoxyphenylacetonitrile, □-(ethylsulfonyloxyimino)-p-methoxyphenylacetonitrile, □-(propylsulfonyloxyimino)-p-methylphenylacetonitrile, and □-(methylsulfonyloxyimino)-p-bromophenylacetonitrile. Of these, □-(methylsulfonyloxyimino)-p-methoxyphenylacetonitrile is preferred.

Amongst the possible diazomethane-based acid generators, specific examples of bisalkyl or bisaryl sulfonyldiazomethanes include bis(isopropylsulfonyl)diazomethane, bis(p-toluenesulfonyl)diazomethane, bis(1,1-dimethylethylsulfonyl)diazomethane, bis(cyclohexylsulfonyl)diazomethane, and bis(2,4-dimethylphenylsulfonyl)diazomethane.

The compounds of the composition (B) can be used singularly, or in combinations of two or more different compounds.

The quantity of the component (B) is typically within a range from 0.5 to 30 parts by weight, and preferably from 1 to 10 parts by weight, per 100 parts by weight of the component (A). If the quantity is lower than the above range, then there is a danger that pattern formation may not progress satisfactorily, whereas if the quantity exceeds the above range it becomes difficult to achieve a uniform solution, and there is also a danger of a deterioration in the storage stability of the composition.

(D) Nitrogen-Containing Organic Compound

In a positive resist composition of the present invention, in order to improve the resist pattern shape and the post exposure stability of the latent image formed by the pattern-wise exposure of the resist layer, a nitrogen-containing organic compound (D) can also be added as a separate, optional component.

A multitude of these nitrogen-containing organic compounds have already been proposed, and any of these known compounds can be used as the component (D), although a secondary lower aliphatic amine or a tertiary lower aliphatic amine is particularly preferred.

Here, a lower aliphatic amine refers to an alkyl or alkyl alcohol amine of no more than 5 carbon atoms, and examples of these secondary and tertiary amines include trimethylamine, diethylamine, triethylamine, di-n-propylamine, tri-n-propylamine, tripentylamine, diethanolamine and triethanolamine, and of these, tertiary alkanolamines such as triethanolamine are particularly preferred.

These compounds may be used singularly, or in combinations of two or more different compounds.

This component (D) is typically added in a quantity within a range from 0.01 to 5.0 parts by weight per 100 parts by weight of the component (A).

Component (E)

Furthermore, in order to prevent any deterioration in sensitivity caused by the addition of the aforementioned component (D), and improve the resist pattern shape and the post exposure stability of the latent image formed by the pattern-wise exposure of the resist layer, an organic carboxylic acid, or a phosphorus oxo acid or derivative thereof can also be added as another optional component (E). Either one, or both of the component (D) and the component (E) can be used.

Examples of suitable organic carboxylic acids include malonic acid, citric acid, malic acid, succinic acid, benzoic acid, and salicylic acid.

Examples of suitable phosphorus oxo acids or derivatives thereof include phosphoric acid or derivatives thereof such as esters, including phosphoric acid, di-n-butyl phosphate and diphenyl phosphate; phosphonic acid or derivatives thereof such as esters, including phosphonic acid, dimethyl phosphonate, di-n-butyl phosphonate, phenylphosphonic acid, diphenyl phosphonate, and dibenzyl phosphonate; and phosphinic acid or derivatives thereof such as esters, including phosphinic acid and phenylphosphinic acid, and of these, phosphonic acid is particularly preferred. The component (E) is typically used in a quantity within a range from 0.01 to 5.0 parts by weight per 100 parts by weight of the component (A).

Organic Solvent (C)

A positive resist composition according to the present invention can be produced by dissolving the required components in a component (C).

The component (C) may be any solvent capable of dissolving the various components to generate a uniform solution, and one or more solvents selected from known materials used as the solvents for conventional chemically amplified resists can be used.

Specific examples of the solvent include γ-butyrolactone; ketones such as acetone, methyl ethyl ketone, cyclohexanone, methyl isoamyl ketone and 2-heptanone; polyhydric alcohols and derivatives thereof such as ethylene glycol, ethylene glycol monoacetate, diethylene glycol, diethylene glycol monoacetate, propylene glycol, propylene glycol monoacetate, dipropylene glycol, or the monomethyl ether, monoethyl ether, monopropyl ether, monobutyl ether or monophenyl ether of dipropylene glycol monoacetate; cyclic ethers such as dioxane; and esters such as methyl lactate, ethyl lactate (EL), methyl acetate, ethyl acetate, butyl acetate, methylpyruvate, ethyl pyruvate, methyl methoxypropionate, and ethyl ethoxypropionate.

These components (C) can be used singularly, or as a mixed solvent containing two or more different solvents.

In particular, mixed solvents of propylene glycol monomethyl ether acetate (PGMEA) and a polar solvent are preferred. The relative proportions (weight ratio) in such a mixed solvent should be determined with due consideration given to factors such as the co-solubility of PGMEA and the polar solvent, but are preferably within a range from 1:9 to 8:2, and even more preferably from 2:8 to 5:5.

More specifically, in those cases where EL is added as the polar solvent, the weight ratio of PGMEA:EL is preferably within a range from 2:8 to 5:5, and even more preferably from 3:7 to 4:6.

Furthermore, mixed solvents containing at least one of PGMEA and EL, together with □-butyrolactone, are also preferred as the component (C). In such cases, the weight ratio of the former and latter components in the mixed solvent is preferably within a range from 70:30 to 95:5.

There are no particular restrictions on the quantity used of the component (C), and this quantity can set in accordance with factors such as enabling favorable application of the composition to a substrate or the like, and achieving the desired coating thickness. Typically, the quantity is sufficient to generate a solid fraction concentration for the resist composition within a range from 2 to 20% by weight, and preferably from 5 to 15% by weight.

Other Optional Components

Other miscible additives can also be added to a positive resist composition of the present invention according to need, and examples include additive resins for improving the properties of the resist film, surfactants for improving the ease of application, dissolution inhibitors, plasticizers, stabilizers, colorants and halation prevention agents.

[Pattern Formation Process]

A resist pattern formed using a photoresist composition produced by the present invention can be formed using normal processes. Namely, a photoresist composition such as that described above is first applied to the surface of a substrate such as a silicon wafer using a spinner or the like, and a prebake (PAB treatment) is then conducted under temperature conditions of 80 to 150□C for 40 to 120 seconds, and preferably for 60 to 90 seconds, thereby forming a resist film. Following selective exposure of the resist film with KrF excimer laser light, ArF excimer laser light, or F₂ excimer laser light, or alternatively Extreme UV (extreme ultraviolet light), an EB (electron beam), or an X-ray beam, through a desired mask pattern using, for example, an exposure apparatus, PEB (post exposure baking) is conducted under temperature conditions of 80 to 1501° C. for 40 to 120 seconds, and preferably for 60 to 90 seconds. Subsequently, developing is conducted using an alkali developing solution such as an aqueous solution of tetramethylammonium hydroxide with a concentration of 1 to 10% by weight. In this manner, a resist pattern that is faithful to the mask pattern can be obtained.

An organic or inorganic anti-reflective film may also be provided between the substrate and the applied layer of the resist composition.

In the present invention, KrF excimer laser light is particularly effective.

In this manner, the present invention provides technology for producing a photoresist composition comprising a hydroxystyrene resin containing hydroxystyrene structural units as the base component, wherein the composition is capable of suppressing the occurrence of defects, and particularly fine scum and microbridges, in the resist pattern following developing. Furthermore, the present invention also provides technology for producing a photoresist composition with superior foreign matter characteristics. In addition, the present invention also provide technology for producing a photoresist composition with excellent storage stability as a resist solution.

Moreover, the present invention also enables the production of a photoresist composition which, even when subjected to filtration treatment, displays little variation in the makeup of the composition, meaning variations in the sensitivity and resist pattern size are also unlikely.

### EXAMPLES

As follows is a more detailed description of the present invention based on a series of examples.

[Evaluation Methods]

The properties of the photoresist compositions produced in the following examples and comparative examples were determined using the methods described below.

(1) Foreign Matter Characteristics and Storage Stability as a Resist Solution

Using a liquid particle counter (product name: KS-41, manufactured by Rion Co., Ltd.), a photoresist composition was evaluated for storage stability as a resist solution by measuring the level of particles immediately following filtration treatment, and then measuring samples that had been stored in a freezer, a refrigerator, or at room temperature (25° C.) for a period of 2 months. The measurement limit is typically about particles/cm³.

(2) Defects

A prepared (positive) photoresist composition was applied to a silicon wafer (diameter: 200 mm) using a spinner, and was then prebaked (PAB treatment) and dried on a hotplate at 110□C for 90 seconds, forming a resist layer with a film thickness of 350 nm.

Subsequently, this layer was selectively irradiated with a KrF excimer laser (248 nm) through a mask pattern, using a KrF exposure apparatus NSR-S203B [manufactured by Nikon Corporation, NA (numerical aperture)=0.60, σ=0.65].

The irradiated resist was then subjected to PEB treatment at 110□C for 90 seconds, subjected to puddle development for 60 seconds at 23□C in a 2.38% by weight aqueous solution of tetramethylammonium hydroxide, and was then washed for 20 seconds with water, and dried, thus yielding a line and space resist pattern with a width of 250 nm.

The number of defects was then measured using a surface defect inspection apparatus KLA 2132 (product name) manufactured by KLA Tencor Corporation, by evaluating the number of defects on the wafer (diameter: 8 inches). Three wafers were tested in each of the examples and comparative examples, and the average value was determined.

In each of the examples and comparative examples, a determination as to whether defects were bridge type defects, wherein adjacent line patterns had linked via a bridge type structure, or scum comprising fine particles in the vicinity of the bottom sections of the pattern, was made by inspection of the resist pattern using a measuring SEM S-9220 (product name, manufactured by Hitachi, Ltd.).

[Production of Photoresist Composition prior to Filtration Treatment]

The materials (A), (B), (D), and (E) and any other components were mixed together and dissolved in the component (C), thus yielding a pre-filtration photoresist composition.

Component (A): 100 parts by weight of a copolymer formed from the structural units listed below [weight average molecular weight (Mw): 10,000, polydispersity (Mw/Mn, wherein Mn is the number average molecular weight): 2.20].

Structural Units

(a1) 71 mol %: a p-hydroxystyrene structural unit of the above general formula (I) wherein R is a hydrogen atom and m=1.

(a2) 12 mol %: a structural unit derived from tert-butyl acrylate, represented by the above general formula (1) wherein R is a hydrogen atom, and R¹¹, R¹², and R¹³ are all methyl groups.

(a3) 17 mol %: a styrene structural unit of the above general formula (II) wherein R is a hydrogen atom and n=0.
Component (B): triphenylsulfonium trifluoromethanesulfonate, in a quantity equivalent to 3 parts by weight per 100 parts by weight of the component (A).
Component (D): triethanolamine, in a quantity equivalent to 0.35 parts by weight per 100 parts by weight of the component (A).
Component (E): salicylic acid, in a quantity equivalent to 0.32 parts by weight per 100 parts by weight of the component (A).
Other component: 1 part by weight of a fluorine-based surfactant FC-171 (product name, manufactured by 3M Corporation).
Component (C): 930 parts by weight of PGMEA
   [Filtration Treatment]

Using the above pre-filtration photoresist composition, the filtration treatments were conducted according to each of the following examples and comparative examples.

The filtration device was similar to the device shown in FIG. 1, and the filtration treatment comprised passing the composition once through a first filtration portion (a first filter), and once through a second filtration portion (a second filter).

In the examples and comparative examples, the first and second filters installed within the filtration device were as described below.

### Example 1

The two filters described below were used. First filter: ULTIPLEAT P-Nylon filter (product name: manufactured by Nihon Pall, Ltd., zeta potential: approximately −16 to −12 mV, pore size: 0.04 μm, critical surface tension: 77 dyne/cm, no charge modification), which is manufactured from nylon 66.

Second filter: a filter manufactured from polypropylene (product name: UNIPORE POLYFIX, manufactured by Kitz Corporation), with a pore size of 0.02 μm, and specifications including a filtration pressure [differential pressure resistance (20° C.)] of 0.4 MPa and a surface area (filtration surface area) of 3400 cm². The filter was a disposable type filter with a diameter of 58 mm and a height of 148.6 mm. The critical surface tension was 29 dyne/cm.

Following filtration, the filtered (positive) photoresist composition was applied to a silicon wafer (diameter: 200 mm) using a spinner, and was then prebaked (PAB treatment) and dried on a hotplate at 110□C for 90 seconds, thus forming a resist layer with a film thickness of 350 nm.

Subsequently, this layer was selectively irradiated with a KrF excimer laser (248 nm) through a mask pattern, using a KrF exposure apparatus NSR—S203B [manufactured by Nikon Corporation, NA (numerical aperture)=0.60, σ=0.65]. The irradiated resist was then subjected to PEB treatment at 110□C for 90 seconds, subjected to puddle development for 60 seconds at 23□C in a 2.38% by weight aqueous solution of tetramethylammonium hydroxide, and was then washed for 20 seconds with water, and dried, thus yielding a line and space resist pattern of favorable shape, with a width of 200 nm.

### Comparative Example 1

The two filters described below were used.

First filter: a filter manufactured from polyethylene (product name: MICROGUARD UPE FILTER, manufactured by Mykrolis Corporation), pore size: 0.05 μm, critical surface tension: 31 dyne/cm.

Second filter: a filter manufactured from polytetrafluoroethylene (product name: Enflon, manufactured by Nihon Pall, Ltd.), with a zeta potential of −20 mV, a pore size of 0.05 μm, and specifications including a filtration pressure [differential pressure resistance (38° C.)] of 3.5 kgf/cm², a surface area (filtration surface area) of 0.13 m², and a critical surface tension of 28 dyne/cm. The filter was a disposable type filter with a diameter of 72 mm and a height of 114.5 mm.

Neither of the first and second filters were nylon filters, and both displayed critical surface tension values of less than 70 dyne/cm.

### Comparative Example 2

The two filters described below were used.

First filter: a filter manufactured from polyethylene (product name: MICROGUARD UPE FILTER, manufactured by Mykrolis Corporation), pore size: 0.05 μm, critical surface tension: 31 dyne/cm.

Second filter: a filter manufactured from polypropylene (product name: UNIPORE POLYFIX, manufactured by Kitz Corporation), with a pore size of 0.02 μm, and specifications including a filtration pressure [differential pressure resistance (20° C.)] of 0.4 MPa and a surface area (filtration surface area) of 3400 cm². The filter was a disposable type filter with a diameter of 58 mm and a height of 148.6 mm. The critical surface tension was 29 dyne/cm.

Neither of the first and second filters were nylon filters, and both displayed critical surface tension values of less than 70 dyne/cm.

### Comparative Example 3

With the exception of replacing the first filter from the example 1 with a nylon N66 POSIDYNE filter (product name, manufactured by Pall Corporation, zeta potential: 18 mV, critical surface tension: 77 dyne/cm, charge modified) with a pore size of 0.1 μm, filtration was conducted in the same manner as the example 1, and when a line and space pattern was then formed in the same manner as the example 1, a 225 nm pattern was formed, indicating a variation in pattern size of 25 nm from that observed in the example 1.

In this comparative example, the pore size of the nylon filtration membrane of the first filter is larger than 0.04 μm.

The results are summarized in Table 1.

TABLE 1

| | Measured value for foreign matter*¹ | | |
|---|---|---|---|
| | 0.15/0.20/0.22/0.30 μm (particles/ml) | | Defects |
| | After filtration | After 2 months storage | (number of |
| | treatment (foreign | (storage stability as | defects on 8 |
| | matter property) | a resist solution) | inch wafer) |
| Example 1 | 7.5/1.6/1.0/0.0 | OK*² | 22 |
| Comparative | exceeded | — | 6306 |
| example 1 | measurement limit | | |
| Comparative | exceeded | — | 135 |
| example 2 | measurement limit | | |

*¹The table entry “0.15/0.20/0.22/0.30 μm (particles/ml)” describes the number of particles with a diameter of at least 0.15 μm but less than 0.20 μm/the number of particles with a diameter of at least 0.20 μm but less than 0.22 μm/the number of particles with a diameter of at least 0.22 μm but less than 0.30 μm/and the number of particles with a diameter of at least 30 μm within 1 mL of the photoresist composition.
*²The entry “OK” for the storage stability as a resist solution indicates that a comparison of samples of the photoresist composition immediately following filtration treatment, after refrigerated storage (5° C.), after frozen storage (−15° C.), and after room temperature storage, revealed almost no variation in the number of foreign matter particles.

There was no variation in the size of the resist patterns formed in the example 1, and the comparative examples 1 and 2, but the resist pattern formed in the comparative example 3 was 25 nm broader.

In other words, in the example 1, there was no variation in characteristics as a result of the filtration treatment, whereas in the comparative example 3, it is clear that the filtration treatment caused a variation in the makeup of the composition.

The storage stability as a resist solution for each of the comparative examples 1 and 2 was not evaluated, as the foreign matter characteristics were unsatisfactory even immediately following filtration treatment.

### Example 2

Using the photoresist composition used in the example 1, and using a P-Nylon filter (product name: manufactured by Nihon Pall, Ltd., zeta potential: approximately −16 to −12 mV, pore size: 0.04 μm, critical surface tension: 77 dyne/cm, no charge modification), equipped with a membrane formed from nylon 66, as the first filter represented by the symbol 12a in FIG. 3, the photoresist composition was filtered using the application device shown in FIG. 3, and when the level of defects was measured in the same manner as that described above in section (2), the result was 25 defects, which represents an extremely favorable result.

From the results of the examples and comparative examples described above it is evident that in the examples according to the present invention, a dramatic improvement in the foreign matter characteristics was achieved simply by altering the filter membrane. The storage stability as a resist solution was also excellent.

Furthermore, the quantities of fine scum and microbridges generated during resist pattern formation were also dramatically reduced.

Moreover, the composition also displayed excellent resist pattern size stability.

While preferred embodiments of the invention have been described and illustrated above, it should be understood that these are exemplary of the invention and are not to be considered as limiting. Additions, omissions, substitutions, and other modifications can be made without departing from the spirit or scope of the present invention. Accordingly, the invention is not to be considered as being limited by the foregoing description, and is only limited by the scope of the appended claims.

1. A process for producing a photoresist composition, comprising a step for passing a photoresist composition, comprising a resin component (A) that satisfies a condition (1) below, an acid generator component (B) that generates acid on exposure, and an organic solvent (C), through a first filter comprising a first filtration membrane that satisfies a condition (2) below, wherein:
(1) said resin component (A) comprises a structural unit (a1) represented by a general formula (I) shown below, and a structural unit (a2) containing an acid dissociable, dissolution inhibiting group, 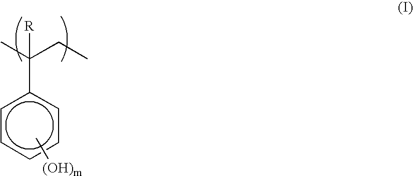
(wherein, R represents a hydrogen atom or a methyl group, and m represents an integer from 1 to 3), and
(2) said first filtration membrane has a critical surface tension of at least 70 dyne/cm, and has not been subjected to charge modification.

2. A process for producing a photoresist composition according to claim 1, wherein as said first filtration membrane, a membrane that displays a zeta potential exceeding −20 mV but no more than 15 mV in distilled water of pH 7.0 is used.

3. A process for producing a photoresist composition according to claim 2, wherein as said first filtration membrane, a membrane that displays a negative zeta potential in distilled water of pH 7.0 is used.

4. A process for producing a photoresist composition according to claim 1, wherein as said first filtration membrane, a nylon membrane is used.

5. A process for producing a photoresist composition according to claim 1, comprising a step for passing said photoresist composition through a second filter comprising a second filtration membrane formed from either polyethylene or polypropylene prior to, and/or after, said step for passing said composition through said first filter.

6. A process for producing a photoresist composition according to claim 5, wherein a pore size of said first filtration membrane and/or said second filtration membrane is within a range from 0.02 μm to 0.1 μm.

7. A process for producing a photoresist composition according to claim 1, wherein a pore size of said first filtration membrane is within a range from 0.02 μm to 0.04 μm.

8. A process for producing a photoresist composition according to claim 7, wherein a pore size of said first filtration membrane is 0.04 μm.

9. A process for producing a photoresist composition according to claim 1, wherein said component (A) comprises, as said structural unit (a2), a structural unit (a2-1) derived from (meth)acrylic acid, in which said acid dissociable, dissolution inhibiting group is a tertiary alkyl group, and further comprises a structural unit (a3) represented by a general formula (II) shown below: 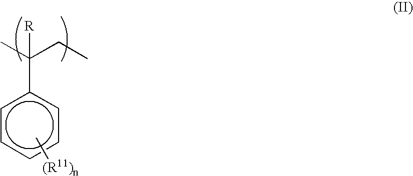
(wherein, R represents a hydrogen atom or a methyl group, R¹¹ represents a lower alkyl group, and n represents either 0, or an integer from 1 to 3).

10. A process for producing a photoresist composition according to claim 9, wherein said acid dissociable, dissolution inhibiting group of said structural unit (a2-1) is a tert-butyl group.

11. A filtration device, comprising a first filtration portion, through which is passed a photoresist composition comprising a resin component (A), an acid generator component (B) that generates acid on exposure, and an organic solvent (C), wherein said filtration device satisfies conditions (i) and (ii) described below:
(i) said first filtration portion comprises a first filter equipped with a first filtration membrane, and said first filtration membrane has a critical surface tension of at least 70 dyne/cm, and has not been subjected to charge modification, and
(ii) said filtration device is used for filtering a photoresist composition containing a resin component (A) that comprises a structural unit (a1) represented by a general formula (I) shown below, and a structural unit (a2) containing an acid dissociable, dissolution inhibiting group: 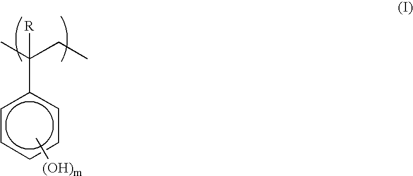
(wherein, R represents a hydrogen atom or a methyl group, and m represents an integer from 1 to 3).

12. A filtration device according to claim 11, wherein said first filtration membrane has a zeta potential exceeding −20 mV but no more than 15 mV in distilled water of pH 7.0.

13. A filtration device according to claim 11, wherein said first filtration membrane has a negative zeta potential in distilled water of pH 7.0.

14. A filtration device according to claim 11, wherein said first filtration membrane is a nylon membrane.

15. A filtration device according to claim 11, further comprising a second filtration portion, with a second filter comprising a second filtration membrane formed from either polyethylene or polypropylene, through which said photoresist composition is passed prior to, and/or after, said first filtration portion.

16. A filtration device according to claim 15, wherein a pore size of said first filtration membrane and/or said second filtration membrane is within a range from 0.02 μm to 0.1 μm.

17. A filtration device according to claim 11, wherein a pore size of said first filtration membrane is within a range from 0.02 μm to 0.04 μm.

18. A filtration device according to claim 17, wherein a pore size of said first filtration membrane is 0.04 μm.

19. An application device for a photoresist composition, comprising a filtration device according to claim 11.

20. A photoresist composition produced by a process for producing a photoresist composition according to claim 1.

21. A process for producing a photoresist composition, comprising a step for passing a photoresist composition, comprising a resin component (A) that satisfies a condition (3) below, an acid generator component (B) that generates acid on exposure, and an organic solvent (C), through a first filter comprising a first filtration membrane that satisfies a condition (4) below, wherein
(3) said resin component (A) comprises a structural unit (a1) represented by a general formula (I) shown below, and a structural unit (a2) containing an acid dissociable, dissolution inhibiting group: 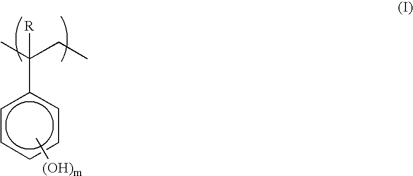
(wherein, R represents a hydrogen atom or a methyl group, and m represents an integer from 1 to 3), and
(4) said first filtration membrane comprises a nylon membrane with a pore size no larger than 0.04 μm.

22. A filtration device comprising a first filtration portion, through which is passed a photoresist composition comprising a resin component (A), an acid generator component (B) that generates acid on exposure, and an organic solvent (C), wherein said filtration device satisfies conditions (iii) and (iv) described below:
(iii) said first filtration portion comprises a first filter equipped with a first filtration membrane, and said first filtration membrane comprises a nylon membrane with a pore size no larger than 0.04 μm, and
(iv) said filtration device is used for filtering a photoresist composition containing a resin component (A) that comprises a structural unit (a1) represented by a general formula (I) shown below, and a structural unit (a2) containing an acid dissociable, dissolution inhibiting group: 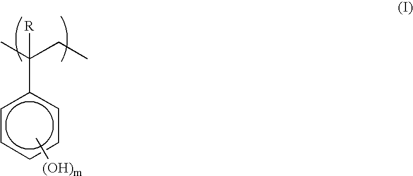
(wherein, R represents a hydrogen atom or a methyl group, and m represents an integer from 1 to 3).

23. An application device for a photoresist composition, comprising a filtration device according to claim 22.
